(19) United States
(12) Patent Application Publication
(10) Pub. No.: US 2013/0186281 A1
(43) Pub. Date: Jul. 25, 2013

(54) COFFEE MAKER FUNNEL

(71) Applicants: Jiangang Guo, Guangdong (CN); Yongchun Zeng, Guangdong (CN)

(72) Inventors: Jiangang Guo, Guangdong (CN); Yongchun Zeng, Guangdong (CN)

(73) Assignee: GUANGDONG XINBAO ELECTRIC JOINT-STOCK LTD., FoShan City, Guangdong (CN)

(21) Appl. No.: 13/825,965

(22) PCT Filed: Nov. 26, 2011
(86) PCT No.: PCT/CN2011/082995

§ 371 Date: Mar. 25, 2013

(30) Foreign Application Priority Data
Sep. 26, 2010 (CN) 201010292995.5

(51) Int. Cl. A47J 31/36

(52) U.S. Cl. CPC A47J 31/36
USPC 99/287

(57) ABSTRACT

A coffee maker funnel comprises a funnel body (1) and a coffee-brewing head assembly (2), The coffee-brewing head assembly (2) comprises a funnel lid (4), a coffee powder press disc body (6), a sprinkler disc (9), and a connecting tube (13). The upper part of the funnel lid (4) is connected to the upper part of the funnel body (1). The lower part of the funnel lid (4) is connected to the upper part of the coffee powder press disc body (6). The connecting tube (13) connects a water inlet joint assembly (11) disposed on the funnel lid (4) and a water outlet joint assembly (10) disposed on the coffee powder press disc body (6). The sprinkler disc (9) is disposed below the water outlet joint assembly (10) and fastened on the bottom of the coffee powder press disc body (6). Disposed between the upper part of the funnel lid (4) and the lower part of the coffee powder press disc body (6) is a spring (5) for compacting coffee powder inside of the funnel body (1). A funnel o-ring, (8) is disposed between the outer wall of the coffee powder press disc body (6) and the inner wall of the funnel body (1), such that a relatively sealed cavity is formed between the coffee powder press disc body (6) and the funnel body (1). The present funnel is technically simple and be operated with ease and flexibility. In addition to enhancing the coffee quality, the funnel is safe, reliable, and low in production cost.

### FIELD OF THE INVENTION

The present invention relates to a funnel of coffee maker and, in particular, to a modified funnel of coffee maker.

### BACKGROUND OF THE INVENTION

Drip coffee makers available on the market directly use a beating device to heat water and flows the heated water through a spray head to uniformly distribute the water onto coffee powder when brewing coffee. During this process, no pressure is applied on the coffee powder, resulting in incomplete extraction of coffee powder. Chinese patent application CN2824794Y, published on 11 Oct. 2006, disclosed a brewing device for coffee maker, which comprises an upper brewing part fixed to the main body of the coffee maker and connected to a water supply, and a lower brewing part connected to the outlet of coffee liquid and matched with the upper brewing part to form a brewing cavity. The lower brewing part is a sprayer. The upper and lower brewing parts can be screwed together. The brewing device of this kind was said to be structurally simple, and the sealed cavity, formed by the connection of the upper and lower brewing parts, improved brewing quality under suitable pressure and temperature. However, the disclosed brewing device has a potential safety problem when the upper brewing part is unintentionally opened during brewing.

### SUMMARY OF THE INVENTION

An object of the present invention is to provide a funnel of coffee maker that is technically simple and operated with ease and flexibility. In addition to enhancing the coffee quality, the funnel is safe, reliable, and low in production cost.

To achieve the object, a funnel for coffee maker is provided which comprises a funnel body and a coffee-brewing head assembly. The funnel body is a hollow container for receiving coffee power of various amounts.

The coffee-brewing head assembly is detachably connected to the funnel body. The coffee-brewing head assembly comprises a funnel lid, a coffee powder press disc body, a sprinkler disc, and a connecting tube. The upper part of the funnel lid is connected to the upper part of the funnel body. The lower part of the funnel lid is connected to the upper part of the coffee powder press disc body. The connecting tube connects a water inlet joint assembly disposed on the funnel lid and a water outlet joint assembly disposed on the coffee powder press disc body. The sprinkler disc is disposed below the water outlet joint assembly and fastened on the bottom of the coffee powder press disc body.

Disposed between the upper part of the funnel lid and the lower part of the coffee powder press disc body is a spring for compacting coffee powder inside of the funnel body. The coffee powder press disc body is movable within the funnel body under the force of the spring and can compact the coffee powder within the Funnel body.

A funnel o-ring is disposed between the outer wall of the coffee powder press disc body and the inner all of the funnel body, such that a relatively sealed cavity is formed between the coffee powder press disc body and the funnel body.

The funnel o-ring is provided on the outside wall of the coffee powder press disc body. The lower part of the funnel lid is detachably connected with the upper part of the coffee powder press disc body. The funnel lid is movably connected to the water inlet joint assembly.

The funnel lid has a snap structure for coupling with the funnel body, such that the funnel lid and the funnel body can be detachably connected.

The connecting tube is a silicone tube. A filter is provided at bottom of the funnel body.

As a spring is provided between the upper part of the funnel lid and the lower part of the coffee powder press disc body, and the coffee powder press disc body is movable within the funnel body under the force of the spring and can compact the coffee powder within the funnel body, the hot water will flow through the compacted coffee powder and be forced to flow through the filter disposed at bottom of the funnel body, such that the coffee liquid flowing out of the filter is produced under a pressure, which improves the quality of coffee liquid. In addition, the funnel o-ring is provided between the outer wall of the coffee powder press disc body and the inner wall of the funnel body such that the funnel o-ring enables to form a sealed cavity between the press disc body and the funnel body to ensure that the use of the funnel is safe and reliable. The funnel of coffee maker provided by the present invention is technically simple and operated with ease and flexibility. In addition to enhancing the coffee quality, the funnel is safe, reliable, and low in production cost.

### BRIEF DESCRIPTION OF THE DRAWINGS

FIG. 1 shows a coffee-brewing head assembly according to one example of the present invention.

FIG. 2 is a sectional view showing the funnel body having a large amount of coffee powder.

FIG. 3 is a sectional view showing the funnel body having a small amount of coffee powder.

FIG. 4 shows a funnel lid according to one example of the present invention.

In the figures, 1-funnel body, 2-coffee-brewing head assembly, 3-filter, 4-funnel Lid, 5-spring, 6-coffee powder press disc assembly, 8-funnel o-ring, 9-sprinkler disc, 10-water outlet joint assembly, 11-water inlet joint assembly, 12-snap structure, 13-connecting tube.

### DETAILED DESCRIPTION OF THE INVENTION

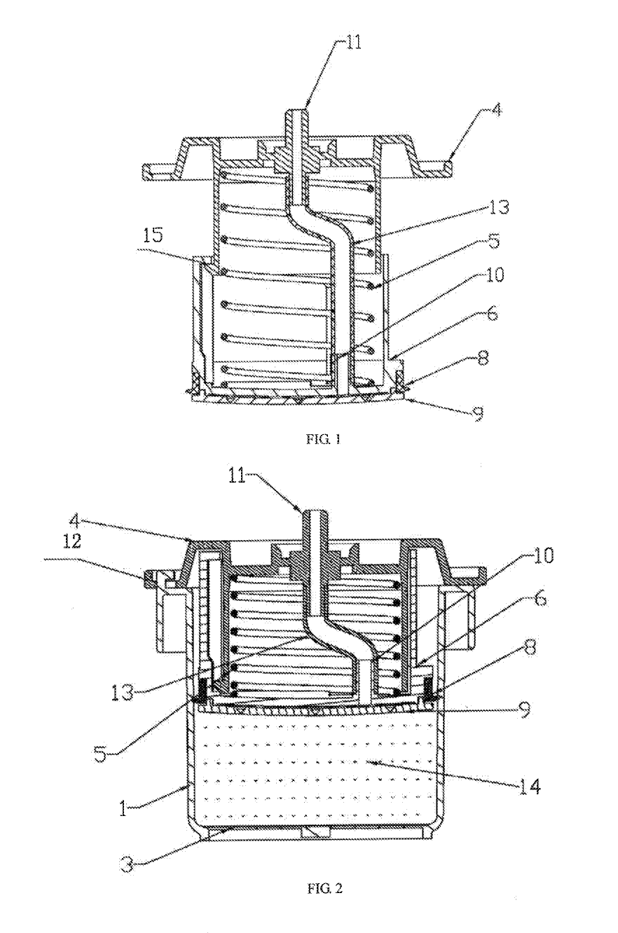

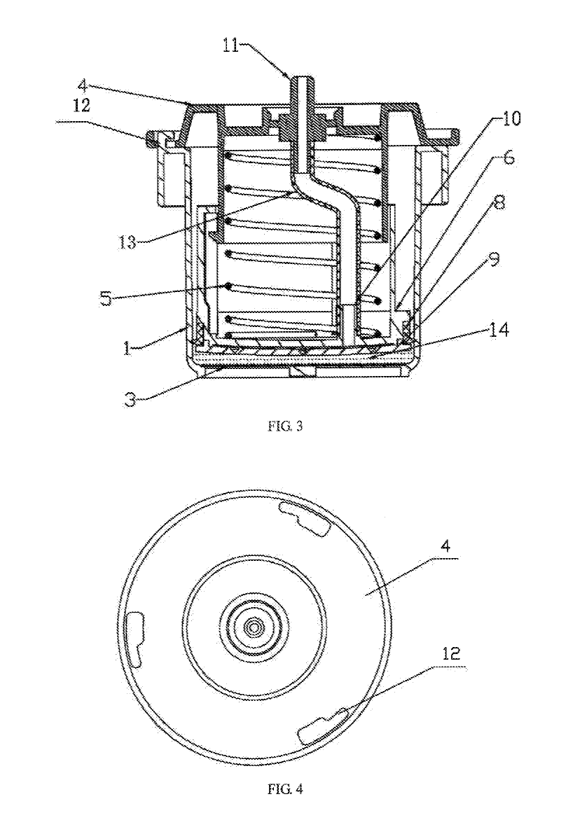

With reference to the FIGS. 1 to 4, a funnel for coffee maker is provided which comprises a funnel body 1 and a coffee-brewing head assembly 2. The funnel body 1 is a hollow container for receiving coffee power 14 of various amounts.

The coffee-brewing head assembly 2 is detachably connected to the funnel body 1. The coffee-brewing head assembly 2 comprises a funnel lid 4, a coffee powder press disc body 6, a spring 5, a sprinkler disc 9, and a connecting tube 13. The upper part of the funnel lid 4 is connected to the upper part of the funnel body 1. The lower part of the funnel lid 4 is connected to the upper part of the coffee powder press disc body 6. The connecting tube 13 connects a water inlet joint assembly 11 disposed an the funnel lid 4 and a water outlet joint assembly 10 disposed on the coffee powder press disc body 6. The sprinkler disc 9 is disposed below the water outlet joint assembly 10 and fastened on the bottom of the coffee powder press disc body 6.

Disposed between the upper part of the funnel lid 4 and the lower part of the coffee powder press disc body 6 is a spring 5 for compacting coffee powder inside of the funnel body 1. The coffee powder press disc body 6 is movable within the funnel body 1 under the force of the spring 5 and can compact the coffee powder 14 within the funnel body 1.

A funnel o-ring 8 is disposed between the outer wall of the coffee powder press disc body 6 and the inner wall of the funnel body 1, such that a relatively sealed cavity is formed between the coffee powder press disc body 6 and the funnel body 1.

In the present example, the connecting tube 13 is a silicone tube. The funnel o-ring is disposed at outer wall of the press disc body 6. in addition, the lower part of the funnel lid 4 is provided with a sliding rail assembly for engaging with the upper part of the press disc body 6.

In the present example, the lower part of the funnel lid 4 is detachably connected to the upper part of the press disc body 6 through a snap structure 15.

The funnel lid 4 is movably connected to the water inlet joint assembly 11. The funnel lid 4 has a snap structure 12 for coupling with the funnel body 1, such that the funnel lid 4 and the fennel body 1 can be detachably connected.

In addition, a filter 3 is provided at bottom of the funnel body 1.

The coffee maker is operated as follows. Coffee powder 14 with variable amounts can be loaded to the funnel body 1 and the latter is covered by the coffee brewing head assembly 2. The press disc assembly 6 of the coffee-brewing head assembly 2 will apply a force on the coffee powder under the effect of the spring 5 to compact the coffee powder 14. Due to the funnel o-ring 8, a relatively sealed cavity is formed between the press disc assembly 6 and the funnel body 1. Hot water flows from the water inlet joint assembly 11 of the funnel lid 4, through the connecting tube 13 and the water outlet joint assembly 10 of the press disc assembly 6, and finally to the sprinkler disc 9 to distribute onto the compacted coffee powder within the sealed cavity.

As the coffee powder is compacted by the press disc assembly 6 and the spring 5, the hot water will flow through the compacted coffee powder and be forced to flow through the filter 3 disposed at bottom of the funnel body 1, such that the coffee liquid flowing out of the filter is produced under a pressure, which improves the quality of coffee liquid.

When brewing coffee, the brewing head assembly 2 is separated from the funnel body 1 and a desired amount of coffee powder is loaded, followed by returning the brewing head assembly 2 back to its position; the whole funnel is then mounted to the coffee maker and the water inlet joint assembly 11 of the funnel lid 4 is connected to water source of the coffee maker; the coffee maker is then actuated to flow water from the water inlet joint assembly 11 of the funnel lid 4, through the connecting tube 13 and the water outlet joint assembly 10 of the press disc assembly 6, and finally to the sprinkler disc 9 to distribute onto the compacted coffee powder within the sealed cavity; if it is desired to continue brewing, the same procedure is repeated.

It should be understood that various example embodiments have been described with reference to the accompanying drawings in which only some example embodiments are shown. The present invention, however, may be embodied in many alternate forms and should not be construed as limited to only the example embodiments set forth herein.

1. A funnel for coffee maker comprising a funnel body and a coffee-brewing head assembly, the funnel body being a hollow container for receiving coffee power of variable amounts, the coffee-brewing head assembly being detachably connected to the funnel body,
wherein the coffee-brewing head assembly comprises a funnel lid, a coffee powder press disc body, a sprinkler disc, and a connecting tube, an upper part of the funnel lid being connected to an upper part of the funnel body, an lower part of the funnel lid being connected to an upper part of the coffee powder press disc body,
wherein the connecting tube is connected with a water inlet joint assembly disposed on the funnel lid and a water outlet joint assembly disposed on the coffee powder press disc body,
wherein the sprinkler disc is disposed below the water outlet joint assembly and fastened on the bottom of the coffee powder press disc body,
wherein disposed between the upper part of the funnel lid and the lower part of the coffee powder press disc body is a spring for compacting coffee powder inside of the funnel body,
wherein the coffee powder press disc body is movable within the funnel body under the force of the spring and capable of compacting the coffee powder within the funnel body, and
wherein a funnel o-ring is disposed between an outer wall of the coffee powder press disc body and an inner wall of the funnel body, such that a relatively sealed cavity is foamed between the coffee powder press disc body and the funnel body.

2. The funnel for coffee maker of claim 1, wherein the funnel o-ring is provided on an outer wall of the coffee powder press disc body.

3. The funnel for coffee maker of claim 1, wherein the lower part of the funnel lid is detachably connected with the upper part of the coffee powder press disc body through a snap structure.

4. The funnel for coffee maker of claim 1, wherein the funnel lid is movably connected to the water inlet joint assembly.

5. The funnel for coffee maker of claim 1, wherein the funnel lid has a snap structure for coupling with the funnel body, such that the funnel lid and the funnel body can be detachably connected.

6. The funnel for coffee maker of claim 1, wherein the connecting tube is a silicone tube.

7. The funnel for coffee maker of claim 1, wherein a filter is provided at bottom of the funnel body.
